(19) United States
(12) Patent Application Publication
(10) Pub. No.: US 2016/0087267 A1
(43) Pub. Date: Mar. 24, 2016

(54) ELECTRODE ACTIVE MATERIAL FOR NONAQUEOUS ELECTROLYTE SECONDARY BATTERY AND NONAQUEOUS ELECTROLYTE SECONDARY BATTERY INCLUDING THE SAME

(71) Applicant: Kabushiki Kaisha Toshiba, Minato-ku (JP)

(72) Inventors: Sara YOSHIO, Taito (JP); Kenji ESSAKI, Kawasaki (JP); Takayuki FUKASAWA, Yokohama (JP); Tomokazu MORITA, Funabashi (JP); Takashi KUBOKl, Ota (JP)

(73) Assignee: Kabushiki Kaisha Toshiba, Minato-ku (JP)

(21) Appl. No.: 14/854,199

(22) Filed: Sep. 15, 2015

(30) Foreign Application Priority Data
Sep. 22, 2014 (JP) 2014-192175

(51) Int. Cl. H01M 4/36; H01M 4/62; H01M 4/38; H01M 4/485; H01M 4/134; H01M 4/131

(52) U.S. Cl. CPC H01M 4/366; H01M 4/134; H01M 4/131; H01M 4/386; H01M 4/485; H01M 4/625

(57) ABSTRACT

An electrode active material for a nonaqueous electrolyte secondary battery includes a composite of a lithium-containing silicon oxide and a silicon-containing compound which contains at least one of silicon and silicon oxide, wherein the lithium-containing silicon oxide contains Li₂Si₂O₅ as a main component.

### CROSS-REFERENCE TO RELATED APPLICATION

This application is based upon and claims the benefit of priority from Japanese Patent Application No. 2014-192175, filed Sep. 22, 2014, the entire contents of which are incorporated herein by reference.

### FIELD

Embodiments described herein relate generally to an electrode active material for a nonaqueous electrolyte secondary battery and a nonaqueous electrolyte secondary battery including the same.

### BACKGROUND

In recent years, the miniaturization technology for electronic devices has been rapidly developed, and various kinds of portable electronic devices are becoming popular. Also, the battery, which is the power supply for these portable electronic devices, has been required to be miniaturized, and the nonaqueous electrolyte secondary battery having high energy density is attracting attention.

In order to increase the energy density of a nonaqueous electrolyte secondary battery, it has been attempted to use the materials which have large lithium storage capacity and high density. Examples of the materials include an amorphous chalcogen compound and elements such as silicon and tin which form an alloy with lithium. Among these materials, silicon can absorb lithium until the atomic ratio Li/Si of lithium atoms to silicon atoms reaches 4.4. Thus, the negative electrode capacity per mass of the negative electrode active material is about 10 times as large as that of graphitic carbon.

However, silicon is characterized in that the volume largely changes associated with the insertion and desorption of lithium in charge and discharge cycle, and there are the problems in the cycle characteristics such as microparticulation of active material particles.

### BRIEF DESCRIPTION OF DRAWINGS

FIG. 1 is a process flow diagram illustrating an example of the production method of the electrode active material for a nonaqueous electrolyte secondary battery according to the first embodiment.

FIG. 2 is a schematic view illustrating the electrode according to the second embodiment.

FIG. 3 is a schematic view illustrating the nonaqueous electrolyte secondary battery according to the third embodiment.

FIG. 4 is a schematic view illustrating the nonaqueous electrolyte secondary battery according to the third embodiment.

FIG. 5 is a schematic view illustrating the nonaqueous electrolyte secondary battery according to the third embodiment.

FIG. 6 is a schematic view illustrating the nonaqueous electrolyte secondary battery according to the third embodiment.

FIG. 7 is a schematic perspective view illustrating the battery pack according to the fourth embodiment.

FIG. 8 is a schematic view illustrating the battery pack according to the fourth embodiment.

FIG. 9 is the X-ray diffraction profile of the negative electrode active material of Example 1.

FIG. 10 is the X-ray diffraction profile of the negative electrode active material of Comparative Example 1.

### DETAILED DESCRIPTION

Hereinafter, embodiments of an electrode active material for a nonaqueous electrolyte secondary battery and a nonaqueous electrolyte secondary battery including the same are described with reference to the drawings.

### First Embodiment

### Electrode Active Material for Nonaqueous Electrolyte Secondary Battery

The first embodiment provides an electrode active material for a nonaqueous electrolyte secondary battery including a composite of a lithium-containing silicon oxide and a silicon-containing compound which contains at least one of silicon and silicon oxide.

The lithium-containing silicon oxide contains Li₂Si₂O₅ as a main component.

Hereinafter, the electrode active material for a nonaqueous electrolyte secondary battery according to the present embodiment is described as a negative electrode active material, but the electrode active material for a nonaqueous electrolyte secondary battery according to the present embodiment can be used even as a positive electrode active material. Herein, the electrode active material for a nonaqueous electrolyte secondary battery according to the present embodiment may be abbreviated as a negative electrode active material. Also, the electrode produced by using the electrode active material for a nonaqueous electrolyte secondary battery according to the present embodiment is described as an electrode used for a nonaqueous electrolyte secondary battery, but the electrode produced by using the electrode active material for a nonaqueous electrolyte secondary battery according to the present embodiment can be used for various batteries.

The A/B, which is a ratio of intensity of a peak A positioned at 24.5° to 25.5° on the (111) face of Li₂Si₂O₅ and intensity of a peak B positioned at 23.3° to 24.0° on the (130) face of Li₂Si₂O₅ in a X-ray diffraction pattern of the composite measured using CuKα radiation, is 1 or more. This is consistent with JCPDS card No. 40-376.

As a lithium-doping amount is increased, a lithium content of a lithium-containing silicon oxide is increased, and a lithium-containing silicon oxide is changed into Li₂Si₂O₅, Li₂SiO₃ and then Li₄SiO₄. Among lithium-free SiO₂ and the aforementioned lithium-containing silicon oxides, Li₂Si₂O₅ is particularly excellent in the compatibility of cycle characteristics and charge and discharge capacity.

The lithium-containing silicon oxide contained in the composite contains Li₂Si₂O₅ as a main component, which means that, when intensity of a peak A positioned at 24.5° to 25.5° on the (111) face of Li₂Si₂O₅, intensity of a peak C positioned at 33.5° to 34.0° on the (200) face of Li₄SiO₄, and intensity of a peak D positioned at 32.5° to 33.5° on the (130) face of Li₂SiO₃ are compared in a X-ray diffraction pattern of the composite measured using CuKα radiation, the intensity of the peak A is larger than the intensity of the peak C, and the intensity of the peak A is at least 0.5 times the intensity of the peak D. This is consistent with JCPDS card No. 40-376, No. 37-1472 and No. 29-828.

The measurement conditions for carrying out an X-ray diffraction (XRD) measurement of the composite to thereby identify a lithium silicate phase are as follows.

### (Sample Preparation)

The composite is ground by a mortar such that the particle size thereof becomes 20 μm or less. Then, the composite is supplied on a glass sample holder, and is rubbed with a glass plate, etc. so as to become flat. In this manner, the composite is placed on a glass sample holder.

### (Measurement Apparatus)

X-ray diffraction measurement apparatus (Model: M18XHF22) manufactured by MAC Science Corporation

### (Measurement Conditions)

Anticathode: Cu

Tube Voltage: 50 kV

Tube Current: 300 mA

Scanning Rate: 1° (2θ)/min

Time Constant: 1 second

Receiving Slit: 0.15 mm

Divergence Slit: 0.5°

Scattering Slit: 0.5°

Because having been already formed by reacting with lithium, Li₂Si₂O₅ has less volume expansion during charge than silicon or a silicon oxide. For this reason, the lithium-containing silicon oxide reduces volume change of a negative electrode active material during charge and discharge, and improves cycle characteristics.

It is preferable that crystal silicon be contained by the silicon-containing compound which is contained in the nonaqueous electrolyte secondary battery according to the present embodiment (hereinafter may be abbreviated as an “electrode active material”). Examples of the silicon-containing compound include a composite formed by coating a silicon particle with a silicon oxide and a conformation having this composite.

In the electrode active material according to the present embodiment, it is preferable that a part or the whole of the silicon-containing compound be coated with the lithium-containing silicon oxide, and it is more preferable that the lithium-containing silicon oxide is almost uniformly present around the silicon-containing compound.

The reason why it is more preferable that the lithium-containing silicon oxide is almost uniformly present around the silicon-containing compound is described below.

In the process of charge and discharge, a volume of silicon changes largely, which causes stress in a part of the lithium-containing silicon oxide which covers the periphery of the silicon-containing compound. When the part which covers the periphery of the silicon-containing compound has high non-uniformity, the load caused by the stress is concentrated locally, and the destruction of the electrode active material is likely to proceed.

The molar ratio Li/Si of lithium atoms contained in the silicon-containing compound and the lithium-containing silicon oxide to silicon atoms contained in the silicon-containing compound and the lithium-containing silicon oxide is 0.01 or higher and lower than 0.6, i.e. 0.01≦Li/S<0.6.

It is necessary that the lithium-containing silicon oxide contain lithium in an amount sufficient to obtain the effect of improving cycle characteristics in terms of the reduction in the stress caused by volume change of silicon. Also, it is necessary that the lithium-containing silicon oxide contain lithium in an amount within the range to allow Li₂Si₂O₅ having the effect of improving cycle characteristics to exist. In other words, when the molar ratio Li/Si of lithium atoms to silicon atoms is within the aforementioned range, the lithium-containing silicon oxide can reduce the stress caused by volume change of silicon, and can improve cycle characteristics.

When the molar ratio Li/Si of lithium atoms to silicon atoms is lower than 0.01, it is impossible to obtain Li₂Si₂O₅ having the effect of improving cycle characteristics, and the effect of improving cycle characteristics is not exerted. Meanwhile, when the molar ratio Li/Si of lithium atoms to silicon atoms is 0.6 or higher, the reaction between silicon and lithium proceed excessively, and Li₄SiO₄ and Li₂SiO₃ are produced locally. For this reason, during charge and discharge, the distortion, which is caused by the difference between the volume expansion coefficients of Li₄SiO₄ and Li₂SiO₃ and the volume expansion coefficient of the other part, is likely to occur at the inside of the silicon-containing compound. In addition, when trying to uniformly produce Li₄SiO₄ and Li₂SiO₃, the doping amount of lithium becomes too large, and thus, it is impossible to obtain a sufficient charge and discharge capacity in a negative electrode material.

The silicon-containing compound and the lithium-containing silicon oxide are integrated through a carbonaceous material.

As a carbonaceous material, it is possible to use at least one selected from the group consisting of graphite, hard carbon, soft carbon, amorphous carbon, a carbon nanofiber, a carbon nanotube and carbon black. These carbonaceous materials are preferable because it is possible to increase the conductivity of a negative electrode material and to prevent the active material particles, which form the inner structure of the electrode active material, from deforming during charge and discharge.

The electrode active material according to the present embodiment is a particle capable of the insertion and desorption of lithium, and the average primary particle size is preferably 1 μm or more and 80 μm or less and more preferably 10 μm or more and 60 μm or less.

The average primary particle size of the electrode active material affects the reaction rates of the insertion and desorption reactions of lithium, and has a large influence on negative electrode characteristics. When the average primary particle size of the negative electrode material is within the aforementioned range, it is possible to stably exert negative electrode characteristics.

Herein, the average primary particle size of the electrode active material is obtained by observing the electrode active materials with a Scanning Electron Microscope (SEM), randomly selecting 10 or more of the negative electrode materials from the obtained image, and calculating the average value of sizes in the randomly selected 10 different directions for the respective negative electrode materials.

The electrode active material according to the present embodiment includes the composite of the lithium-containing silicon oxide and the silicon-containing compound which contains at least one of silicon and silicon oxide, wherein the lithium-containing silicon oxide contains Li₂Si₂O₅ as a main component, and therefore, it is possible to reduce the stress caused by volume change of silicon and to improve cycle characteristics when the electrode active material is used for a negative electrode.

### “Production Method of Electrode Active Material for Nonaqueous Electrolyte Secondary Battery”

Next, an example of the production method of the electrode active material according to the present embodiment is described in detail with reference to FIG. 1.

FIG. 1 is a process flow diagram illustrating an example of the production method of the electrode active material according to the present embodiment.

The production method of the electrode active material according to the present embodiment includes the melt reaction step of mixing a lithium salt and silicon-containing particles which contain at least one of silicon and silicon oxide and subjecting the resultant mixture to a thermal treatment at 600° C. or higher and 900° C. or lower under an inert atmosphere. Through this melt reaction step, the silicon-containing compound and the lithium-containing silicon oxide are obtained.

The time for the thermal treatment is set within a range 1 hour to 12 hours.

It is preferable that the silicon-containing particles contain crystal silicon. Examples of the silicon-containing particle include a composite formed by coating a silicon particle with a silicon oxide and a conformation having this composite.

In the thermal treatment for a lithium salt and the silicon-containing particles, a lithium salt and the silicon-containing particles are mixed and then subjected to the thermal treatment. Through this treatment, the lithium-containing silicon oxide can be formed by causing the reaction of a lithium salt and a silicon oxide contained in the silicon-containing particles.

As a lithium salt, it is preferable to use a lithium salt having a melting point of 300° C. or lower such as lithium acetate or lithium nitrate. Among these lithium salts, it is preferable to use lithium acetate.

The reason why it is preferable to use lithium acetate is as follows. Because the melting point of lithium acetate is 256° C., lithium acetate forms a liquid phase at a low temperature, and can be uniformly reacted with the silicon-containing particles. As a result, a part or the whole of the silicon-containing compound can be coated with the lithium-containing silicon oxide.

In the production method of the electrode active material according to the present embodiment, it is possible to use lithium hydroxide, etc. as well as lithium acetate as the lithium salt. However, because the melting point of lithium hydroxide is 462° C., uneven distribution is likely to occur in the phase formed by lithium-containing silicon oxide.

In the melt reaction step, the molar ratio Li/Si of lithium atoms contained in the lithium salt to silicon atoms contained in the silicon-containing particles is preferably 0.02 or higher and lower than 0.7, i.e. 0.02≦Li/S<0.7.

When the molar ratio Li/Si of lithium atoms to silicon atoms is within the aforementioned range, Li₂Si₂O₅ can exist in the lithium-containing silicon oxide produced by the melt reaction step in an amount sufficient to obtain the effect of improving cycle characteristics.

When the molar ratio Li/Si of lithium atoms to silicon atoms is lower than 0.02, it is impossible to obtain Li₂Si₂O₅ having the effect of improving cycle characteristics, and the effect of improving cycle characteristics is not exerted. Meanwhile, when the molar ratio Li/Si of lithium atoms to silicon atoms is 0.7 or higher, the reaction between silicon and lithium proceed excessively, and Li₄SiO₄ and Li₂SiO₃ are produced locally. For this reason, during charge and discharge, the distortion, which is caused by the difference between the volume expansion coefficients of Li₄SiO₄ and Li₂SiO₃ and the volume expansion coefficient of the other part, is likely to occur at the inside of the silicon-containing compound.

Also, the production method of the electrode active material according to the present embodiment can include the thermal treatment step of heating a precursor of the silicon-containing particles at 900° C. or higher and 1,200° C. or lower under an inert atmosphere, to thereby obtain the silicon-containing particles.

The time for the thermal treatment is set within a range 1 hour to 12 hours.

Preferable examples of a precursor of the silicon-containing particles include the fine particles produced by preparing SiOₓ (0.8≦X≦1.5) fine particles or the mixed powder of silicon and SiOₓ as a raw material, and rapidly heating this raw material followed by rapidly cooling.

The average primary particle size of the fine particles which are the precursor of the silicon-containing particle is preferably 10 nm or more and 1,000 nm or less.

When the silicon-containing compound and the lithium-containing silicon oxide are used as the electrode active material, the silicon-containing compound and the lithium-containing silicon oxide are integrated through a carbonaceous material.

Examples of the integration method of the silicon-containing compound and the lithium-containing silicon oxide include the method of mixing the silicon-containing compound, the lithium-containing silicon oxide and a carbon precursor in a liquid phase formed by using a dispersion medium, and drying and solidifying the resultant mixture followed by burning.

As a carbon precursor, it is possible to use an organic compound which is liquid at room temperature and is easy to be polymerized. An organic compound can be a monomer or an oligomer. Examples of an organic compound include a furan resin, a xylene resin, a ketone resin, an amino resin, a melamine resin, a urea resin, an aniline resin, a urethane resin, a polyimide resin, a polyester resin and a phenolic resin, and monomers thereof. Specific examples of a monomer include furan compounds such as furfuryl alcohol, furfural and a furfural derivative. These monomers are polymerized in the liquid phase including the silicon-containing compound and the lithium-containing silicon oxide, to thereby integrate the silicon-containing compound and the lithium-containing silicon oxide. A polymerization method of the organic compound varies according to the type of the organic compound, and examples thereof include the method of adding hydrochloric acid or an acid anhydride in the liquid phase including the organic compound, or the method of heating the liquid phase containing the organic compound.

Also, solid powders such as sucrose, ascorbic acid and citric acid can be used as a carbon precursor.

Examples of a dispersion medium include water, ethanol, isopropyl alcohol, acetone, N-methyl-2-pyrrolidone (NMP), methyl ethyl ketone, and fatty acids such as oleic acid and linoleic acid. Among these, a dispersion medium, which is not reacted with the silicon-containing compound, the lithium-containing silicon oxide and the carbon precursor, is preferred.

The mixing method of the silicon-containing compound, the lithium-containing silicon oxide and the carbon precursor by using the dispersion medium can be the solid kneading method in which a liquid phase amount is less than a solid phase amount. Alternatively, the mixing method can be the mixing and stirring method in which a liquid phase amount is more than a solid phase amount. The mixing and stirring method can be carried out by for example various types of stirrer, a ball mill, a bead mill apparatus, or a combination thereof. Also, the silicon-containing compound, the lithium-containing silicon oxide and the carbon precursor can be mixed while being heated in a part of the mixing process.

The mixture obtained by mixing is subjected to drying and solidification.

The drying of the mixture is carried out by allowing the mixture to stand in atmosphere or heating the mixture.

The solidification of the dried mixture may be carried out by polymerizing the organic compounds as described above or by simultaneously drying and polymerizing the organic compounds. The drying method and the solidification method are appropriately selected according to the type of the carbon precursor.

Herein, the particles, which is obtained by the composite treatment the integration of the silicon-containing compound and the lithium-containing silicon oxide through the carbonaceous material), can be coated with the carbonaceous material.

Examples of the coating material include the material, which is converted into the carbonaceous material through heating under an inert atmosphere, such as pitch, a resin or a polymer. Specifically, preferable examples of the coating material include the material, which is well carbonized through the burning at approximately 1,200° C., such as petroleum pitch, mesophase pitch, a furan resin, cellulose or rubbers.

Examples of the coating method, in which the particles obtained by the composite treatment are coated with the carbonaceous material, include the method of polymerizing monomers in the state where the composite particles (the silicon-containing compound and the lithium-containing silicon oxide) are dispersed in the monomers, and then, burning and carbonizing the obtained solidified material. In addition, examples of the coating method include the method of dissolving the polymers in a solvent so as to disperse the composite particles, and then, burning and carbonizing the solidified material obtained by evaporating a solvent.

Also, examples of the coating method, in which the particles obtained by the composite treatment are coated with the carbonaceous material, include the method using a CVD (Chemical Vapor Deposition) method. In this method, the gaseous carbon source is flowed on the sample (the particles obtained by the composite treatment) heated at 800° C. or higher and 1,000° C. or lower while using an inert gas as a carrier gas, and the carbon source is carbonized on the surface of the sample.

Usable examples of the carbon source include benzene, toluene and styrene. Also, the burning and carbonizing can be carried out at the same time as the coating with the carbonaceous material because the sample is heated at 800° C. or higher and 1,000° C. or lower when the sample is coated with the carbonaceous material by a CVD method.

Also, a lithium compound and a SiO₂ source can be simultaneously added in the carbon source when the sample is coated with the carbonaceous material by a CVD method.

Also, when the particles obtained by the composite treatment and the particles obtained by coating the particles with the carbonaceous material are subjected to X-ray diffraction measurements, it is preferable that the base change caused by hard carbon is small and the measurement results are the same as each other.

Also, in order to maintain the structure of the negative electrode active material particles and to prevent the aggregation of the silicon-containing particles, zirconia or stabilized zirconia is preferably contained in the negative electrode active material. The cycle characteristics are improved by preventing aggregation of the silicon-containing particles.

According to the production method of the electrode active material for a nonaqueous electrolyte secondary battery according to the present embodiment, the electrode active material includes the composite of the lithium-containing silicon oxide and the silicon-containing compound which contains at least one of silicon and silicon oxide, wherein the lithium-containing silicon oxide contains Li₂Si₂O₅ as a main component, and therefore, it is possible to reduce the stress caused by volume change of silicon and to improve cycle characteristics when the electrode active material is used for a negative electrode.

### Second Embodiment

The second embodiment provides the electrode including the current collector and the electrode mixture layer which is formed on the current collector and contains the binder and the electrode active material for a nonaqueous electrolyte secondary battery according to the first embodiment.

In other words, the electrode according to the present embodiment includes the current collector and the electrode mixture layer which is formed on the current collector and contains the binder and the electrode active material for a nonaqueous electrolyte secondary battery according to the first embodiment.

Hereinafter, the electrode according to the present embodiment is described as a negative electrode, but the electrode according to the present embodiment can be used even as a positive electrode. Also, the electrode according to the present embodiment is described as an electrode used for a nonaqueous electrolyte secondary battery, but the electrode according to the present embodiment can be used for various batteries.

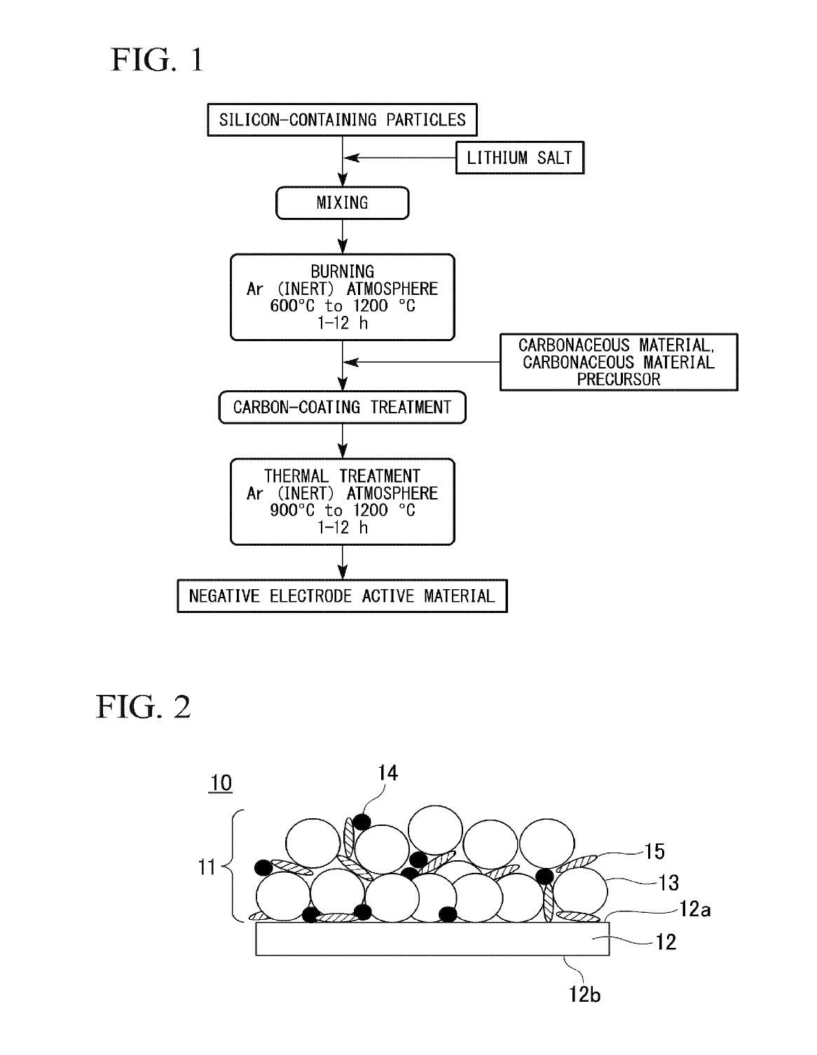

Hereinafter, the negative electrode according to the present invention is described in details with reference to FIG. 2.

FIG. 2 is a schematic view illustrating the electrode according to the present embodiment.

The negative electrode 10 according to the present embodiment includes the negative electrode mixture layer and the negative electrode current collector 12.

The negative electrode mixture layer 11 is the layer which is placed on the one surface 12a of the negative electrode current collector 12 and is formed of the mixture containing the electrode active material for a nonaqueous electrolyte secondary battery according to the first embodiment. The negative electrode mixture layer 11 contains the aforementioned electrode active material for a nonaqueous electrolyte secondary battery according to the first embodiment, the conductive agent 14 and the biding agent 15. The binder 15 binds the electrode mixture layer 11 and the negative electrode current collector 12. Herein, the conductive material 14 and the binder 15 are optional components.

The thickness of the negative electrode mixture layer 11 on one surface is preferably within a range of 1.0 μm or more and 150 μm or less, and more preferably within a range of 30 μm or more and 100 μm or less. Therefore, when the negative electrode mixture layers 11 are provided on the both surfaces (the one surface 12a and the other surface 12b) of the negative electrode current collector 12, the total thickness of the negative electrode mixture layers 11 is within a range of 2.0 μm or more and 300 μm of less.

When the thickness of the negative electrode mixture layer 11 is within the aforementioned range, the large current discharge characteristics and cycle characteristics of the nonaqueous electrolyte secondary battery including a positive electrode are improved significantly.

Regarding the blending ratio of the negative electrode active material 13, the conductive agent 14 and the binder 15 in the negative electrode mixture layer 11, the negative electrode active material 13 is preferably blended within a range of 57 mass % or more and 95 mass % or less, the conductive agent is preferably blended within a range of 3 mass % or more and 20 mass % or less, and the binder is preferably blended within a range of 2 wt % or more and 40 wt % or less. When the blending ratio is within the aforementioned range, it is possible to obtain the good large current discharge characteristics and cycle characteristics in the nonaqueous electrolyte secondary battery including the negative electrode 10.

The negative electrode current collector 12 is the conductive member to be bound with the negative electrode mixture layer 11. As the negative electrode current collector 12, it is possible to use a conductive substrate having a porous structure or a non-porous conductive substrate. These conductive substrates can be formed of copper, stainless steel or nickel, etc.

The thickness of the negative electrode current collector 12 is preferably within a range of 5 μm to 20 μm. When the thickness of the negative electrode current collector 12 is within the range, it is possible to achieve the balance between electrode strength and reduction in weight.

The conducting agent 14 improves the current collection performance of the negative electrode active material 13 and suppresses contact resistance between the negative electrode active material 13 and the negative electrode current collector 12.

Examples of the conducting agent 14 include acetylene black, carbon black, coke, a carbon fiber, graphite, a metal compound powder and a metal powder. Preferable examples of the conducting agent 14 include coke, graphite and a metal compound powder such as TiO, TiC, TiN, Al, Ni, Cu and Fe, in which the thermal treatment temperature is within a range of 800° C. to 2,000° C. and the average particle size is 10 μm or less.

The type of the conducting agent 14 can be one, or two or more.

The binder 15 fills the gaps between the dispersed negative electrode active materials 13 so as to bind the negative active material 13 and the conducting agent 14 and to bind the negative electrode active material 13 and the negative electrode current collector 12.

Examples of the binder 15 include organic compounds containing polytetrafluoroethylene (PTFE), polyvinylidene fluoride (PVdF), fluorine-based rubber, styrene-butadiene rubber, a core shell binder and polyacrylic acid.

The type of the binder 15 can be one, or two or more.

Next, the production method of the negative electrode 10 is described.

Firstly, the negative electrode active material 13, the conducting agent 14 and the binder 15 are suspended in a general solvent so as to prepare a slurry.

Subsequently, the slurry is applied onto one surface 12a of the negative electrode current collector 12 followed by drying to form the negative electrode mixture layer 11. Then, the negative electrode mixture layer 11 is subjected to pressing, to thereby obtain the negative electrode 10.

By controlling the pressure of pressing, it is possible to adjust the embedding amount of the negative electrode active material 13 into the negative electrode current collector 12. It is not preferable that the pressure of pressing be lower than 0.2 kN/cm because the embedding of the negative electrode active material 13 into the negative electrode current collector 12 hardly occurs. Meanwhile, it is not preferable that the pressure of pressing be higher than 10 kN/cm because the breakage of the negative electrode current collector 12 and the negative electrode active material 13 occurs. Therefore, the pressure of pressing for the negative electrode mixture layer 11 obtained by drying the slurry is preferably 0.5 kN/cm or higher and 5 kN/cm or lower.

### Third Embodiment

The third embodiment provides a nonaqueous electrolyte secondary battery comprising the negative electrode which contains the electrode active material for a nonaqueous electrolyte secondary battery according to the aforementioned first embodiment as the negative electrode active material, a positive electrode, a nonaqueous electrolyte, a separator and an exterior material.

More specifically, the nonaqueous electrolyte secondary battery according to the present embodiment includes an exterior material, a positive electrode that is housed in the external material, the negative electrode that is spatially separated from the positive electrode and is housed in the external material with a separator interposed therebetween, and a nonaqueous electrolyte charged in the external material.

Hereinafter, the negative electrode, the positive electrode, the nonaqueous electrolyte, the separator and the exterior material, which are constituent members of the nonaqueous electrolyte secondary battery according to the present embodiment, are described in detail.

### (1) Negative Electrode

As the negative electrode, the aforementioned negative electrode according to the second embodiment is used.

### (2) Positive Electrode

The positive electrode includes the positive electrode current collector and the positive electrode mixture layer that is formed on one surface or both surfaces of the positive electrode current collector and contains a positive electrode active material, a conducting agent and a binder. A conductive agent and a binder are an optional component.

The thickness of the positive electrode mixture layer on one surface is preferably within a range of 1.0 μm or more and 150 μm or less, and more preferably within a range of 30 μm or more and 120 μm or less. For this reason, when the positive electrode mixture layers are provided on the both surfaces of the positive electrode current collector, the total thickness of the positive electrode mixture layers is within a range of 2.0 μm or more and 300 μm or less.

When the thickness of the positive electrode mixture layer is within the aforementioned range, the large current discharge characteristics and cycle characteristics of the nonaqueous electrolyte secondary battery including a positive electrode are improved significantly.

As the positive electrode active material, an oxide or a sulfide can be used. Examples of an oxide and a sulfide include manganese dioxide (MnO₂) which absorbs lithium, an iron oxide, a copper oxide, a nickel oxide, a lithium-manganese composite oxide (such as LiₓMn₂O₄ or LiₓMnO₂), a lithium-nickel composite oxide (such as LiₓNiO₂), a lithium-cobalt composite oxide (such as LiₓCoO₂), a lithium-nickel-cobalt composite oxide (such as LiNiₓMn_{y}Co_{1-y}O₂), a lithium-manganese-cobalt composite oxide (such as LiₓMn_{y}Co_{1-y}O₂), a lithium-manganese-nickel composite oxide (such as LiₓMn_{2-y}Ni_{y}O₄) having a spinel structure, a lithium-phosphorus oxide (such as LiₓFePO₄, LiₓFe_{1-y}Mn_{y}PO₄, or LiₓCoPO₄) having an olivine structure, iron sulfate (Fe₂(SO₄)₃), a vanadium oxide (such as V₂O₅), and a lithium-nickel-cobalt-manganese composite oxide. In the aforementioned chemical formulae, x and y satisfy the relational expressions of “0<x≦1” and “0≦y≦1”, respectively. As the positive electrode active material, these compounds can be used alone or in combination of two or more.

The positive electrode active material is preferably a compound having a high positive electrode voltage, and more preferable examples of the positive electrode active material include a lithium-manganese composite oxide (such as LiₓMn₂O₄), a lithium-nickel composite oxide (LiₓNiO₂), a lithium-cobalt composite oxide (LiₓCoO₂), a lithium-nickel-cobalt composite oxide (LiNi_{1-y}Co_{y}O₂), a lithium-manganese-nickel composite oxide (LiₓMn_{2-y}Ni₃O₄) having a spinel structure, a lithium-manganese-cobalt composite oxide (LiₓMn_{y}Co_{1-y}O₂), a lithium iron phosphate (LiₓFePO₄), and a lithium-nickel-cobalt-manganese composite oxide. In the aforementioned chemical formulae, x and y satisfy the relational expressions of “0<x≦1” and “0≦y≦1”, respectively.

In the case where an ambient temperature molten salt is used as the nonaqueous electrolyte of the nonaqueous electrolyte secondary battery, preferable examples of the positive electrode active material include a lithium iron phosphate, LiₓVPO₄F (0≦x≦1), a lithium-manganese composite oxide, a lithium-nickel composite oxide, or a lithium-nickel-cobalt composite oxide. Because these compounds have less reactivity with an ambient temperature molten salt, it is possible to improve the cycle lifespan of the nonaqueous electrolyte secondary battery.

The average primary particle size of the positive electrode active material is preferably within a range of 100 nm to 1 μm. When the average primary particle size of the positive electrode active material is 100 nm or more, it is easy to handle in industrial manufacturing. Also, when the average primary particle size of the positive electrode active material is 1 μm or less, it is possible to make the lithium ion diffusion in solid proceed smoothly.

The conducting agent improves the current collection performance of the positive electrode active material and suppresses contact resistance between the positive electrode active material and the positive current collector. Examples of the conducting agent include agents containing acetylene black, carbon black, artificial graphite, natural graphite, a carbon fiber, and a conductive polymer.

The type of the conducting agent can be one, or two or more.

The binder fills the gap between the dispersed positive electrode active materials so as to bind the positive electrode active material and the conducting agent and to bind the positive electrode active material and the positive electrode current collector.

Examples of the binder include the organic materials such as polytetrafluoroethylene (PTFE), polyvinylidene fluoride (PVdF), and fluorine-based rubber and polyacrylic acid.

The type of the hinder can be one, or two or more.

Also, examples of an organic solvent for dispersing the binder include N-methyl-2-pyrrolidone (NMP) and dimethylformamide (DMF).

Regarding the blending ratio of the positive electrode active material, the conductive agent and the binder in the positive electrode mixture layer, the positive electrode active material is preferably blended within a range of 80 mass % or more and 95 mass % or less, the conductive agent is preferably blended within a range of 3 mass % or more and 20 mass % or less, and the binder is preferably blended within a range of 2 wt % or more and 7 wt % or less. When the blending ratio is within the aforementioned range, it is possible to obtain the good large current discharge characteristics and cycle characteristics in the nonaqueous electrolyte secondary battery including the positive electrode.

The positive electrode current collector is the conductive member to be bound with the positive electrode mixture layer. As the positive electrode current collector, a conductive substrate having a porous structure or a non-porous conductive substrate can be used.

The thickness of the positive electrode current collector is preferably within a range of 5 μm to 20 μm. When the thickness of the positive electrode current collector is within the range, it is possible to achieve the balance between electrode strength and reduction in weight.

Next, the production method of the positive electrode is described.

Firstly, the positive electrode active material, the conducting agent and the binder are suspended in a general solvent so as to prepare slurry.

Subsequently, the slurry is applied on the positive electrode current collector followed by drying to form the positive electrode mixture layer. Then, the positive electrode mixture layer is subjected to pressing, to thereby obtain the positive electrode.

Also, the positive electrode can be produced by molding the positive electrode active material, the binder and the conducting agent to be blended according to need in a pellet shape to form the positive electrode mixture layer, and disposing this positive electrode mixture layer on the positive electrode current collector.

### (3) Nonaqueous Electrolyte

As the nonaqueous electrolyte, a nonaqueous electrolyte solution, an electrolyte-impregnated polymer electrolyte, a polymer electrolyte or an inorganic solid electrolyte are used.

A nonaqueous electrolyte solution is a liquid nonaqueous electrolyte prepared by dissolving an electrolyte in a nonaqueous solvent (an organic solvent), and is held in the gap in the electrode group.

As a nonaqueous solvent, it is preferable to use the solvent which mainly contains the mixed solvent of cyclic carbonates (hereinafter, referred to as the “first solvent”) such as ethylene carbonate (EC), propylene carbonate (PC) and vinylene carbonate, and nonaqueous solvents having lower viscosity than the cyclic carbonates (hereinafter, referred to as the “second solvent”).

Examples of the second solvent include chain carbonates such as dimethyl carbonate (DMC), diethyl carbonate (DEC) and methylethyl carbonate (MEC); ethyl propionate; methyl propionate; γ-butyrolactone (GBL); acetonitrile (AN); ethyl acetate (EA); toluene; xylene; and methyl acetate (MA). These second solvents can be used alone or in a mixed solvent form of two or more. In particular, it is more preferable that the second solvent have a donor number of 16.5 or less.

It is preferable that the viscosity of the second solvent be 2.8 cmp or less at 25° C. The blending percentage of ethylene carbonate or propylene carbonate in the mixed solvent of the first solvent and the second solvent is preferably 1.0 vol % or more and 80 vol % or less, and more preferably 20 vol % or more and 75 vol % or less.

Examples of an electrolyte contained in a nonaqueous electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃) and lithium bistrifluoromethylsulfonimide [LiN(CF₃SO₂)₂]. Among these, it is preferable to use lithium hexafluorophosphate or lithium tetrafluoroborate.

It is preferable that dissolving amount of the electrolyte to the nonaqueous solvent contained in nonaqueous electrolyte be 0.5 mol/L or more and 2.0 mol/L or less.

### (4) Separator

The separator is placed between the positive electrode and the negative electrode.

The separator 4 is formed of a porous film such as polyethylene (PE), polypropylene (PP), cellulose or polyvinylidene fluoride (PVdF), or a nonwoven fabric made of a synthetic resin, for example. Among these, a porous film formed of polyethylene or polypropylene is preferable because this kind of film can be melt at a certain temperature so as to block a current, which can improve safety.

The thickness of the separator is preferably 5 μm or more and 30 μm or less, and more preferably 10 μm or more and 25 μm or less. When the thickness of the separator is less than 5 μm, the strength of the separator is significantly deteriorated, and there is the possibility that the internal short circuit is likely to occur. Meanwhile, when the thickness of the separator is more than 30 μm, the distance between the positive electrode and the negative electrode is increased, and there is the possibility that the internal resistance is increased.

When the separator is allowed to stand for 1 hour at 120° C., the thermal shrinkage percentage is preferably 20% or less and more preferably 15% or less. When the thermal shrinkage percentage of the separator is more than 20%, there is the increased possibility that heating causes the short circuit between the positive electrode and the negative electrode.

The porosity of the separator is preferably 30% or more and 70% or less and more preferably 35% or more and 70% or less.

The reason why the porosity of the separator is preferably within the aforementioned range is as follows. When the porosity is less than 30%, there is the possibility that the high electrolyte-holding property cannot be obtained in the separator. Meanwhile, when the porosity is higher than 70%, there is the possibility that the sufficient strength cannot be obtained in the separator.

The air permeability of the separator is preferably 30 seconds/100 cm³ or more and 500 seconds/100 cm³ or less and more preferably 50 seconds/100 cm³ or more and 300 seconds/100 cm³ or less.

When the air permeability is less than 30 seconds/100 cm³, there is the possibility that the sufficient strength cannot be obtained in the separator. Meanwhile when the air permeability is higher than 500 seconds/100 cm³, there is the possibility that the high lithium ion mobility cannot be obtained in the separator.

### (5) Exterior Material

As the exterior material which houses the positive electrode, the negative electrode and the nonaqueous electrolyte, a metal container or an exterior container made of a laminated film.

As a metal container, the metal can formed of aluminum, an aluminum alloy, iron or stainless steel in a rectangular or cylindrical shape is used. Also, the thickness of the metal container is preferably 1 mm or less, more preferably 0.5 mm or less and much more preferably 0.2 mm or less.

As an aluminum alloy, an alloy containing an element such as magnesium, zinc or silicon is preferred. When a transition metal such as iron, copper, nickel or chromium is contained in the aluminum alloy, the content of the transition metal is preferably 100 ppm or less. Because the metal container made of the aluminum alloy has the much greater strength than the metal container made of aluminum, the thickness of the metal container can be reduced. As a result, it is possible to realize the thin and lightweight nonaqueous electrolyte secondary battery which has high power and excellent heat radiation property.

Examples of a laminated film include a multi-layer film in which an aluminum foil is coated with a resin film. Usable examples of a resin constituting a resin film include a polymer material such as polypropylene (PP), polyethylene (PE), nylon or polyethylene terephthalate (PET). Also, the thickness of the laminated film is preferably 0.5 mm or less and more preferably 0.2 mm or less. The purity of an aluminum foil is preferably 99.5% or more.

Herein, the present embodiment can be applied to the nonaqueous electrolyte battery having various shapes such as a flat type (thin type), a square type, a cylindrical type, a coin type and a button type.

Also, the nonaqueous electrolyte secondary battery according to the present embodiment can further include a lead which is electrically connected to the electrode group containing the positive electrode and the negative electrode. For example, the nonaqueous electrolyte secondary battery according to the present embodiment can include two leads. In this case, one of the leads is electrically connected to the positive electrode current collector tab and the other lead is electrically connected to the negative electrode current collector tab.

The material of the lead is not particularly limited, but for example, the same material for the positive electrode current collector and the negative electrode current collector is used.

The nonaqueous electrolyte secondary battery according to the present embodiment can further include a terminal which is electrically connected to the aforementioned lead and is drawn from the aforementioned exterior material. For example, the nonaqueous electrolyte secondary battery according to the present embodiment can include two terminals. In this case, one of the terminals is connected to the lead which is electrically connected to the positive electrode current collector tab and the other terminal is connected to the lead which is electrically connected to the negative electrode current collector tab.

The material of the terminal is not particularly limited, but for example, the same material for the positive electrode current collector and the negative electrode current collector is used.

### (6) Nonaqueous Electrolyte Secondary Battery

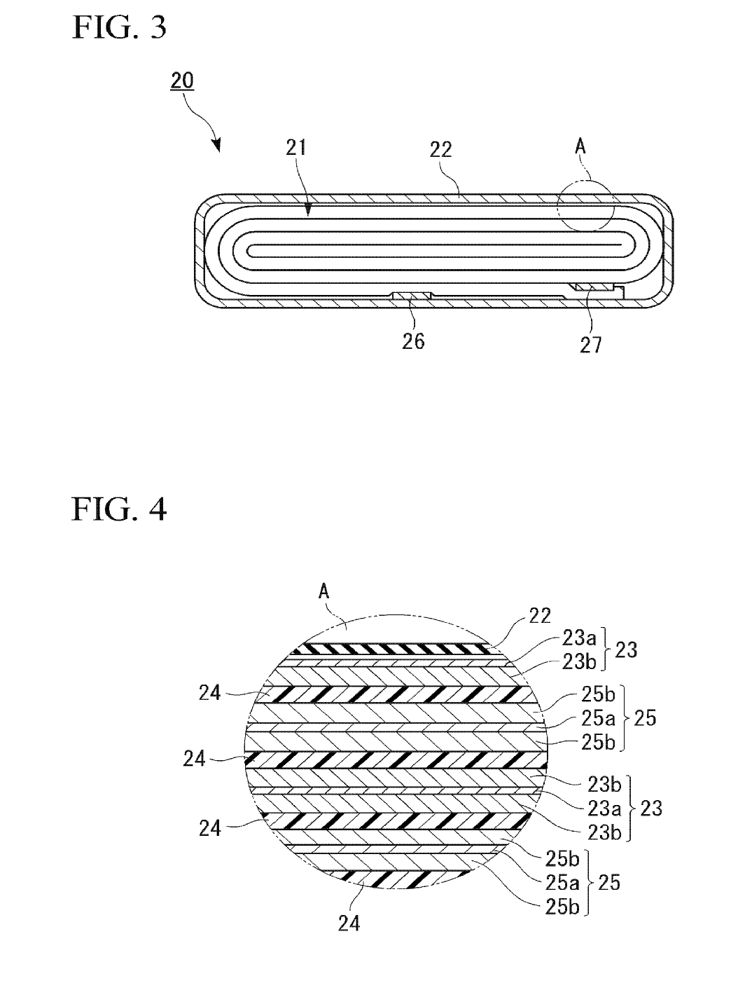

Next, the flat type nonaqueous electrolyte secondary battery (nonaqueous electrolyte secondary battery) 20 illustrated in FIG. 3 and FIG. 4 is described as an example of the nonaqueous electrolyte secondary battery according to the present embodiment. FIG. 3 is a schematic sectional view illustrating the cross-section of the flat type nonaqueous electrolyte secondary battery 20. FIG. 4 is an enlarged sectional view illustrating the part A illustrated in FIG. 3. These drawings are schematic diagrams for describing the nonaqueous electrolyte secondary battery according to the embodiment. The shapes, dimensions, ratios, and the like are different from those of actual device at some parts, but design of the shape, dimensions, ratios, and the like can be appropriately modified in consideration of the following description and known technologies.

The flat type nonaqueous electrolyte secondary battery 20 illustrated in FIG. 3 is configured such that the winding electrode group 21 with a flat shape is housed in the exterior material 22. The exterior material 22 may be a container obtained by forming a laminated film in a bag-like shape or may be a metal container. Also, the winding electrode group 21 with the flat shape is formed by spirally winding the laminated product obtained by laminating the negative electrode 23, the separator 24, the positive electrode 25 and the separator 24 from the outside, i.e. the side of the exterior material 22, in this order, followed by performing press-molding. As illustrated in FIG. 4, the negative electrode 23 located at the outermost periphery has the configuration in which the negative electrode layer 23b is formed on one surface of the negative electrode current collector 23a on the inner surface side. The negative electrodes 23 at the parts other than the outermost periphery have the configuration in which the negative electrode layers 23b are formed on both surfaces of the negative current collector 23a. Also, the positive electrode 25 has the configuration in which the positive electrode layers 25b are formed on both surfaces of the positive current collector 25a. Herein, a gel-like nonaqueous electrolyte can be used instead of the separator 4.

In the vicinity of the outer peripheral end of the winding electrode group 21 illustrated in FIG. 3, the negative electrode terminal 26 is electrically connected to the negative current collector 23a of the negative electrode 23 of the outermost periphery. The positive electrode terminal 27 is electrically connected to the positive current collector 25a of the inner positive electrode 25. The negative electrode terminal 26 and the positive electrode terminal 27 extend toward the outer part of the exterior material 22, and are connected to the extraction electrodes included in the exterior material 22.

When manufacturing the nonaqueous electrolyte secondary battery 20 including the exterior material formed of the laminated film, the winding electrode group 21 to which the negative electrode terminal 26 and the positive electrode terminal 27 are connected is charged in the exterior material 22 having the bag-like shape with an opening, the liquid nonaqueous electrolyte is injected from the opening of the exterior material 22, and the opening of the exterior material 22 with the hag-like shape is subjected to heat-sealing in the state of sandwiching the negative electrode terminal 26 and the positive electrode terminal 27 therebetween. Through this process, the winding electrode group 21 and the liquid nonaqueous electrolyte are completely sealed.

Also, when manufacturing the nonaqueous electrolyte battery 20 having the exterior material formed of the metal container, the winding electrode group 21 to which the negative electrode terminal 26 and the positive electrode terminal 27 are connected is charged in the metal container having an opening, the liquid nonaqueous electrolyte is injected from the opening of the exterior material 22, and the opening is sealed by mounting a cover member on the metal container.

For the negative electrode terminal 26, it is possible to use the material having electric stability and conductivity within a range of a potential equal to or nobler than 1 V and equal to or lower than 3 V with respect to lithium, for example. Specific examples of this material include aluminum and an aluminum alloy containing an element such as Mg, Ti, Zn, Mn, Fe, Cu or Si. Also, it is more preferable that the negative electrode terminal 26 be formed of the same material as the negative current collector 23a in order to reduce the contact resistance with the negative current collector 23a.

For the positive electrode terminal 27, it is possible to use the material having electric stability and conductivity within a range of a potential equal to or nobler than 3 V and equal to or lower than 4.25 V with respect to lithium. Specific examples of this material include aluminum and an aluminum alloy containing an element such as Mg, Ti, Zn, Mn, Fe, Cu or Si. It is more preferable that the positive electrode terminal 27 be formed of the same material as the positive current collector 25a in order to reduce the contact resistance with the positive current collector 25a.

Hereinafter, the exterior material 22, the negative electrode 23, the positive electrode 25, the separator 24, and the nonaqueous electrolyte which are constituent members of the nonaqueous electrolyte battery 20 is described in detail.

### (1) Exterior Material

As the exterior material 22, the aforementioned exterior material is used.

### (2) Negative Electrode

As the negative electrode 23, the aforementioned negative electrode is used.

### (3) Positive Electrode

As the positive electrode 25, the aforementioned positive electrode is used.

### (4) Separator

As the separator 24, the aforementioned separator is used.

### (5) Nonaqueous Electrolyte

As the nonaqueous electrolyte, the aforementioned nonaqueous electrolyte is used.

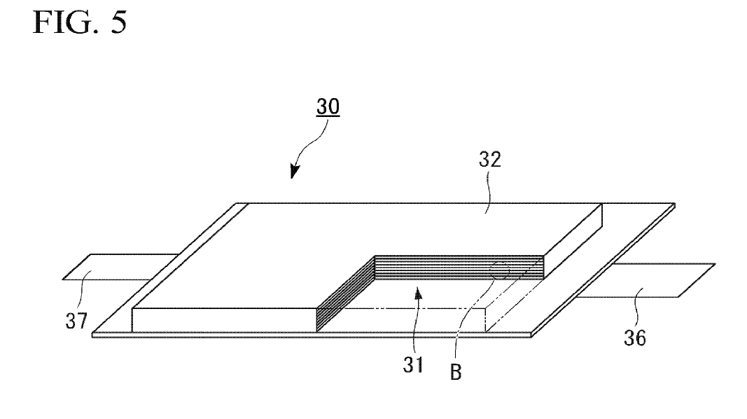

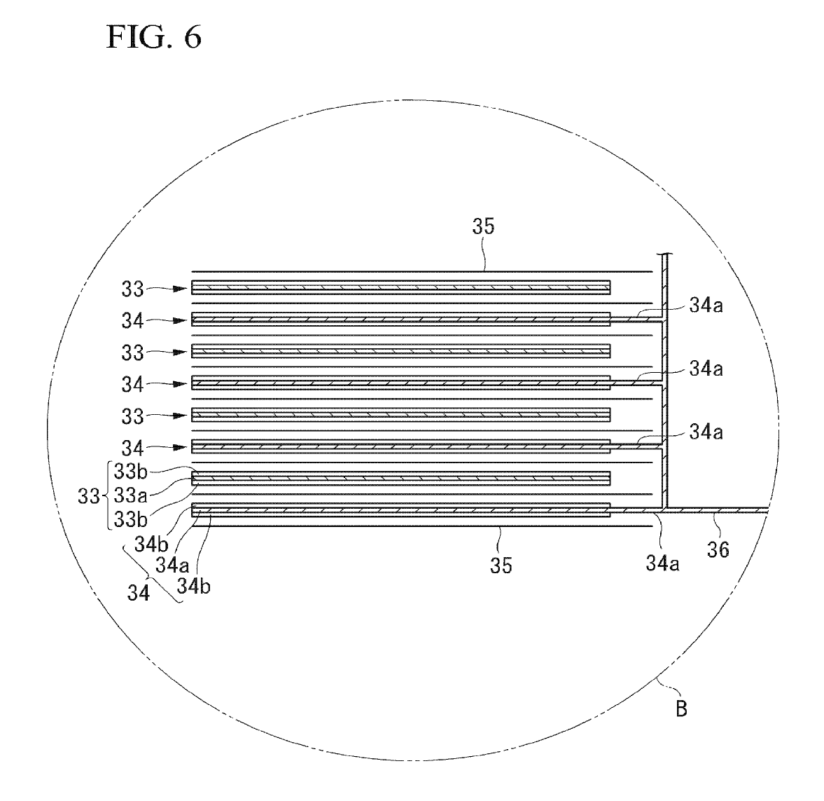

The configuration of the nonaqueous electrolyte secondary battery according to the third embodiment is not limited to the aforementioned configuration illustrated in FIG. 3 and FIG. 4. For example, the batteries having the configurations illustrated in FIG. 5 and FIG. 6 can be used. FIG. 5 is a partial cutout perspective view schematically illustrating another flat type nonaqueous electrolyte secondary battery according to the third embodiment. FIG. 6 is an enlarged schematic sectional view illustrating the part B of FIG. 5.

The nonaqueous electrolyte secondary battery 30 illustrated in FIG. 5 and FIG. 6 is configured such that the lamination type electrode group 31 is housed in the exterior member 32. As illustrated in FIG. 6, the lamination type electrode group 31 has the structure in which the positive electrodes 33 and negative electrodes 34 are alternately laminated while interposing separators 15 therebetween.

The plurality of positive electrodes 33 are present and each includes the positive electrode current collector 33a and the positive electrode layers 33b supported on both surfaces of the positive electrode current collector 33a. The positive electrode layer 33b contains the positive electrode active material.

The plurality of negative electrodes 34 are present and each includes the negative electrode current collector 34a and the negative electrode layers 34b supported on both surfaces of the negative electrode current collector 34a. The negative electrode layer 34b contains the negative electrode active material. One side of the negative electrode current collector 34a of each negative electrode 34 protrudes from the negative electrode 34. The protruding negative electrode current collector 34a is electrically connected to a strip-shaped negative electrode terminal 36. The front end of the strip-shaped negative electrode terminal 36 is drawn from the exterior member 32 to the outside. Although not illustrated, in the positive electrode current collector 33a of the positive electrode 33, the side located opposite to the protruding side of the negative electrode current collector 34a protrudes from the positive electrode 33. The positive electrode current collector 33a protruding from the positive electrode 33 is electrically connected to the strip-shaped positive electrode terminal 37. The front end of the strip-shaped positive electrode terminal 37 is located on an opposite side to the negative electrode terminal 36, and is drawn from the side of the exterior member 12 to the outside.

The material, a mixture ratio, dimensions, and the like of each member included in the nonaqueous electrolyte secondary battery 30 illustrated in FIG. 5 and FIG. 6 are configured to be the same as those of each constituent member of the nonaqueous electrolyte secondary battery 20 described in FIG. 3 and FIG. 4.

According to the present embodiment described above, it is possible to provide the nonaqueous electrolyte secondary battery.

The nonaqueous electrolyte secondary battery according to the present embodiment includes the positive electrode, the negative electrode, the separator and the nonaqueous electrolyte. The negative electrode includes the composite of the lithium-containing silicon oxide and the silicon-containing compound which contains at least one of silicon and silicon oxide, wherein the lithium-containing silicon oxide contains Li₂Si₂O₅ as a main component. This kind of nonaqueous electrolyte secondary battery has the excellent cycle characteristics because stress caused by volume change of silicon is reduced.

### Fourth Embodiment

Next, the nonaqueous electrolyte secondary battery pack according to the fourth embodiment is described in detail.

The nonaqueous electrolyte secondary battery pack according to the present embodiment includes at least one nonaqueous electrolyte secondary battery according to the aforementioned third embodiment (i.e. a single battery). When the plurality of single batteries are included in the nonaqueous electrolyte secondary battery pack, the respective single batteries are disposed so as to be electrically connected in series, in parallel, or in series and parallel.

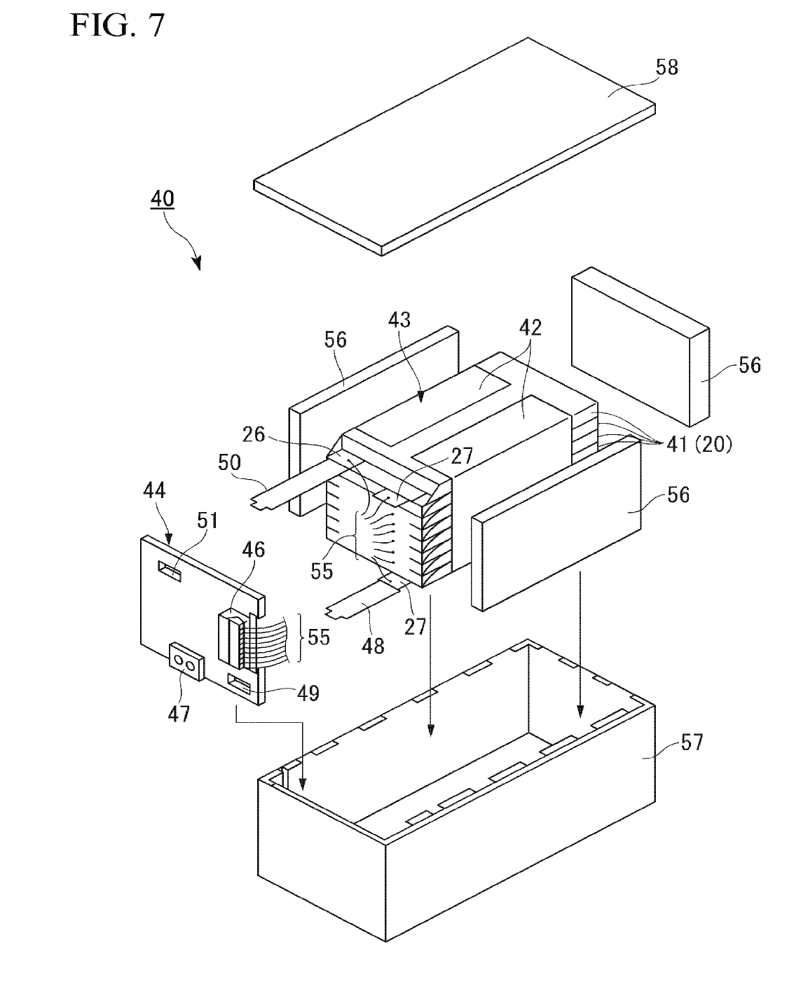

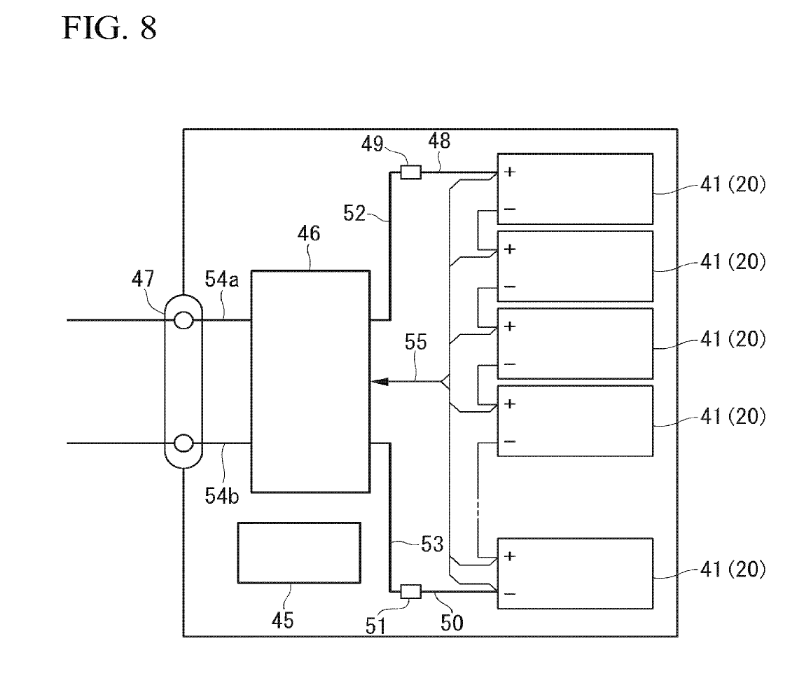

Referring to FIG. 7 and FIG. 8, the nonaqueous electrolyte secondary battery pack 40 according to the present embodiment is described in detail. In the battery pack 40 illustrated in FIG. 7, the flat type nonaqueous electrolyte battery 20 illustrated in FIG. 3 is used as the single battery 41.

The plurality of single batteries 41 are laminated so that the negative electrode terminals 26 and the positive electrode terminals 27 extending to the outside are arranged in the same direction, and thus the assembled batteries 43 are configured by fastening with the adhesive tape 42. These single batteries 41 are connected mutually and electrically in series, as illustrated in FIG. 7 and FIG. 8.

The printed wiring board 44 is disposed to face the side surfaces of the single batteries 41 in which the negative electrode terminals 26 and the positive electrode terminals 27 extend. As illustrated in FIG. 7, the thermistor 45 (see FIG. 8), the protective circuit 46 and the electrifying terminal 47 to an external device are mounted on the printed wiring board 44. Herein, an insulation plate (not illustrated) is mounted on the surface of the printed wiring board 44 facing the assembled batteries 43 in order to avoid unnecessary connection with wirings of the assembled batteries 43.

The positive electrode-side lead 48 is connected to the positive electrode terminal 27 located in the lowermost layer of the assembled batteries 43, and the front end of the positive electrode-side lead 48 is inserted into the positive electrode-side connector 49 of the printed wiring board 44 to be electrically connected. The negative electrode-side lead 50 is connected to the negative electrode terminal 26 located in the uppermost layer of the assembled batteries 43, and the front end of the negative electrode-side lead 50 is inserted into the negative electrode-side connector 51 of the printed wiring board 44 to be electrically connected. These positive electrode-side connector 49 and negative electrode-side connector 51 are connected to the protective circuit 46 via wirings 52 and 53 (see FIG. 8) formed in the printed wiring board 44.

The thermistor 45 is used to detect a temperature of the single battery 41. Although not illustrated in FIG. 7, the thermistor 45 is installed near the single batteries 41, and a detection signal is transmitted to the protective circuit 46. The protective circuit 46 can block the plus-side wiring 54a and the minus-side wiring 54b between the protective circuit 46 and the electrifying terminal 47 for an external device under a predetermined condition. Here, for example, the predetermined condition means that the detection temperature of the thermistor 45 becomes equal to or greater than a predetermined temperature. In addition, the predetermined condition also means that an overcharge, overdischarge, overcurrent, or the like of the single battery 21 be detected. The detection of the overcharge or the like is performed for the respective single batteries 41 or all of the single batteries 41. Herein, when the overcharge or the like is detected in the respective single batteries 41, a battery voltage may be detected, or a positive electrode potential or a negative electrode potential may be detected. In the latter case, a lithium electrode used as a reference electrode is inserted into the respective single batteries 41. In the case of FIG. 7 and FIG. 8, wirings 55 for voltage detection are connected to the respective single batteries 41 and detection signals are transmitted to the protective circuit 46 via the wirings 55.

As illustrated in FIG. 7, the protective sheets 56 formed of rubber or resin are disposed on three side surfaces of the assembled batteries 43 excluding the side surface from which the positive electrode terminals 27 and the negative electrode terminals 26 protrude.

The assembled batteries 43 are stored together with the respective protective sheets 56 and the printed wiring board 44 in the storing container 57. That is, the protective sheets 56 are disposed on both of the inner surfaces of the storing container 57 in the longer side direction and the inner surface in the shorter side direction, and the printed wiring board 44 is disposed on the inner surface opposite to the protective sheet 56 in the shorter side direction. The assembled batteries 43 are located in a space surrounded by the protective sheets 56 and the printed wiring board 44. The cover 58 is mounted on the upper surface of the storing container 57.

When the assembled batteries 43 are fixed, a thermal shrinkage tape may be used instead of the adhesive tape 42. In this case, protective sheets are disposed on both side surfaces of the assembled batteries, the thermal shrinkage tape is circled, and then the thermal shrinkage tape is subjected to thermal shrinkage, so that the assembled batteries are fastened.

Here, in FIG. 7 and FIG. 8, the single batteries 41 connected in series are illustrated. However, to increase a battery capacity, the single batteries 41 may be connected in parallel or may be connected in a combination form of series connection and parallel connection. The assembled battery packs can also be connected in series or in parallel.

According to the aforementioned present embodiment, it is possible to provide the nonaqueous electrolyte secondary battery pack. The nonaqueous electrolyte secondary battery pack according to the present embodiment includes at least one of the aforementioned nonaqueous electrolyte secondary battery according to the third embodiment.

This kind of nonaqueous electrolyte secondary battery pack can show low internal resistance and high durability at high temperature.

Herein, the form of the nonaqueous electrolyte secondary battery pack can be appropriately modified according to a use application. A use application of the nonaqueous electrolyte secondary battery pack according to the embodiment is preferably one which is required to show excellent cycle characteristics when a large current is extracted. Specifically, the battery pack can be used for power of digital cameras, a two-wheeled or four-wheeled hybrid electric vehicle, a two-wheeled or four-wheeled electric vehicle, an assist bicycle, and the like. In particular, the nonaqueous electrolyte secondary battery pack using the nonaqueous electrolyte secondary batteries with excellent high temperature characteristics is appropriately used for vehicles.

According to the present embodiment, it is possible to provide the nonaqueous electrolyte secondary battery pack which is excellent in productivity and cycle characteristics.

### EXAMPLES

Hereinafter, the aforementioned embodiments are described on the basis of the examples.

### Example 1

Through the following procedure, the negative electrode active material of Example 1 was produced.

The silicon monoxide powder (−325 mesh, manufactured by Sigma-Aldrich Co. LLC.) was subjected to the wet pulverization treatment, to thereby obtain the powder having an average primary particle size of approximately 150 nm. This powder was used as the silicon-containing particle precursor.

The silicon-containing particle precursor prepared in the aforementioned manner was heated at 1,100° C. for 3 hours under an inert atmosphere, to thereby obtain the silicon-containing particle.

Subsequently, the aforementioned silicon-containing particle 44 g was mixed with lithium acetate 6.6 g. Then, the mixture was heated at 700° C. for 3 hours under an inert atmosphere, to thereby obtain the composite powder in which a part or the whole of the silicon-containing compound is coated with the lithium-containing silicon oxide.

Subsequently, graphite 0.9 g, the phenol resin 4.4 g and ethanol 11 g were added to the composite powder 3.2 g, and moreover YSZ balls (the particle size: 0.2 mm) were added thereto. Then, the aforementioned materials were mixed by using the planetary ball mill.

Subsequently, the liquid was separated from YSZ balls by a suction filtration method, and the obtained liquid was spread and dried on the hot plate. Then, the liquid was heated at 150° C. for 2 hours, to thereby obtain the solidified material.

The obtained solidified material was burned at 1,100° C. for 3 hours under argon atmosphere.

The burned material was pulverized in the agate mortar, and was sieved to thereby obtain the negative electrode active material having an average primary particle size of 20 μm.

### “Evaluation of Electrochemical Properties”

### (Preparation of Electrochemical Measurement Cell)

The graphite 15 wt % having an average primary particle size of 3 μm and the polyimide 16 wt % were added to the obtained negative electrode active material, and the obtained mixture were kneaded using NMP as a dispersion medium, to thereby produce the electrode slurry.

Subsequently, the electrode slurry was applied and rolled on the copper foil having a thickness of 12 μm, and then was subjected to the thermal treatment at 400° C. for 2 hours under argon atmosphere. Then, the electrode slurry subjected to the thermal treatment was cut into a predetermined size, and further was vacuum dried at 100° C. for 12 hours, to thereby obtain the test electrode.

The aforementioned test electrode, the metal lithium foil which was a counter electrode and a reference electrode, and the nonaqueous electrolyte were used to produce the electrochemical measurement cell under an argon atmosphere. The 1 M solution, which was produced by dissolving LiPF₆ in the mixed solvent of ethylene carbonate (EC) and diethyl carbonate (DEC) (EC:DEC=1:2 (volume ratio)), was used as the nonaqueous electrolyte.

### (Electrochemical Measurement)

The aforementioned electrochemical measurement cell was used to carry out the charge and discharge test at room temperature.

The conditions for the charge and discharge test were as follows. The electrochemical measurement cell was charged at a current density of 1 mA/cm² until the potential difference between the reference electrode and the test electrode became 0.01 V, the constant voltage charge was carried out at 0.01 V for 24 hours, and then, the electrochemical measurement cell was discharged at a current density of 1 mA/cm² until the potential difference became 1.5 V.

In addition, the electrochemical measurement cell was charged at a current density of 1 mA/cm² until the potential difference between the reference electrode and the test electrode became 0.01 V, and then, the electrochemical measurement cell was discharged at a current density of 1 mA/cm² until the potential difference became 1.5 V. This charge and discharge cycle was repeatedly carried out while measuring the transition of the discharge capacity. The cycle number, at which the discharge capacity was reduced to 80% of the initial discharge capacity, was evaluated as 80% capacity-maintaining cycle number. The results are shown in Table 1.

### “X-Ray Diffraction Measurement of Negative Electrode Active Material”

The negative electrode active material obtained in Example 1 was subjected to the X-ray diffraction measurement, to thereby identify a lithium silicate phase in the negative electrode active material. The X-ray diffraction measurement was carried out using X-ray diffraction measurement apparatus (Model: M18XHF22) manufactured by MAC Science Corporation. Also, the measurement conditions were set as follows.

Anticathode: Cu

Tube Voltage: 50 kV

Tube Current: 300 mA

Scanning Rate: 1° (2θ)/min

Time Constant: 1 second

Receiving Slit: 0.15 mm

Divergence Slit: 0.5°

Scattering Slit: 0.5°

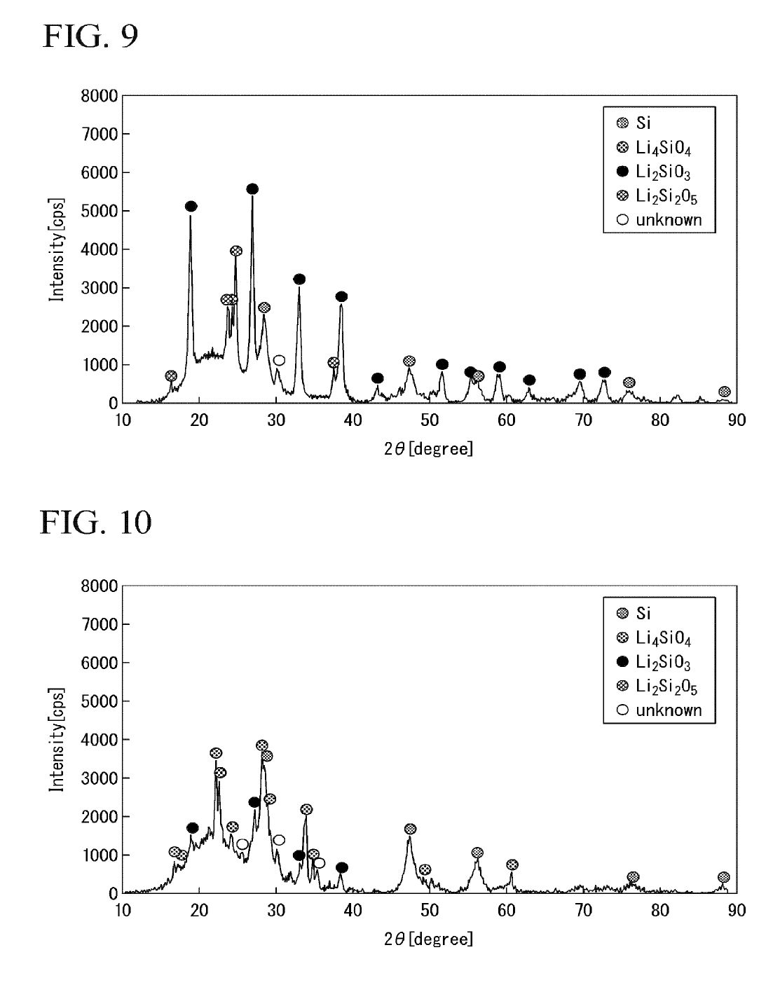

Li₂Si₂O₅ was identified by confirming that A/B, which is the ratio of the intensity of the peak A whose diffraction angle is positioned at 24.5° to 25.5° and the intensity of the peak B whose diffraction angle is positioned at 23.3° to 24.0° in the diffraction pattern, shows 1 or more. The results are shown in Table 1. Also, FIG. 9 shows the X-ray diffraction profile of the negative electrode active material of Example 1.

### “Composition Analysis”

The negative electrode active material obtained described above was subjected to the composition analysis. In other words, the molar ratio of the lithium atoms, which were contained in the silicon-containing compound and the lithium-containing silicon oxide before charge and discharge, to the silicon atoms, which were contained in the silicon-containing compound and the lithium-containing silicon oxide before charge and discharge, was measured by the composition analysis. The composition analysis was carried out by using the following apparatus. The results are shown in Table 1.

Si: ICP emission spectrometer using alkaline fusion-internal standard method (Model: SPS-3520UV, manufactured by Hitachi High-Tech Science Corporation)

O: Analyzer using inert gas fusion-infrared absorption method (Model: TC-600, manufactured by LECO Corporation)

C: Analyzer using high frequency combustion heating-infrared absorption method (Model: CS-444LS, manufactured by manufactured by LECO Corporation)

### Example 2

The negative electrode active material of Example 2 was produced in the same manner as in Example 1 except for using lithium acetate 1.3 g.

By using the obtained negative active material, the test electrode was produced in the same manner as in Example 1, and further, the electrochemical measurement cell was produced.

The obtained electrochemical measurement cell was subjected to the electrochemical measurement in the same manner as in Example 1. The results are shown in Table 1.

Also, the negative electrode active material of Example 2 was subjected to the X-ray diffraction measurement and the composition analysis in the same manner as in Example 1. The results are shown in Table 1.

### Example 3

The negative electrode active material of Example 3 was produced in the same manner as in Example 1 except for using lithium acetate 13.2 g.

By using the obtained negative active material, the test electrode was produced in the same manner as in Example 1, and further, the electrochemical measurement cell was produced.

The obtained electrochemical measurement cell was subjected to the electrochemical measurement in the same manner as in Example 1. The results are shown in Table 1.

Also, the negative electrode active material of Example 3 was subjected to the X-ray diffraction measurement and the composition analysis in the same manner as in Example 1. The results are shown in Table 1.

### Comparative Example 1

The negative electrode active material of Comparative Example 1 was produced in the same manner as in Example 1 except that lithium acetate was used and lithium dope was not carried out for the silicon-containing compound.

By using the obtained negative active material, the test electrode was produced in the same manner as in Example 1, and further, the electrochemical measurement cell was produced.

The obtained electrochemical measurement cell was subjected to the electrochemical measurement in the same manner as in Example 1. The results are shown in Table 1.

Also, the negative electrode active material of Comparative Example 1 was subjected to the X-ray diffraction measurement and the composition analysis in the same manner as in Example 1. The results are shown in Table 1.

Also, FIG. 10 shows the X-ray diffraction profile of the negative electrode active material of Comparative Example 1.

### Comparative Example 1

The negative electrode active material of Comparative Example 1 was produced in the same manner as in Example 1 except for using lithium acetate 46.2 g.

By using the obtained negative active material, the test electrode was produced in the same manner as in Example 1, and further, the electrochemical measurement cell was produced.

The obtained electrochemical measurement cell was subjected to the electrochemical measurement in the same manner as in Example 1. The results are shown in Table 1.

Also, the negative electrode active material of Comparative Example 2 was subjected to the X-ray diffraction measurement and the composition analysis in the same manner as in Example 1. The results are shown in Table 1.

Table 1 shows the results of the charge and discharge tests for Examples 1, 2 and 3 and Comparative Examples 1 and 2, and the molar ratio of the lithium atoms, which were contained in the silicon-containing compound and the lithium-containing silicon oxide before charge and discharge, to the silicon atoms which were contained in the silicon-containing compound and the lithium-containing silicon oxide before charge and discharge.

TABLE 1

| | | 80% Capacity- | |
|---|---|---|---|
| | Initial Discharge | Maintaining Cycle | Molar Ratio to |
| | Capacity | Number | Lithium Atom |
| Example 1 | 941 | 280 | 0.1 |
| Example 2 | 906 | 252 | 0.02 |
| Example 3 | 836 | 298 | 0.19 |
| Comparative | 1,118 | 196 | 0 |
| Example 1 | | | |
| Comparative | 600 | 306 | 0.62 |
| Example 2 | | | |

The results of FIG. 9 identified Li₂Si₂O₅ as a main component in Example 1.

Meanwhile, the results of FIG. 10 identified Li₄SiO₄ and Li₂SiO₃ as main components in Comparative Example 2.

Also, the measurement results of the charge and discharge characteristics shown in Table 1 revealed that in Examples 1, 2 and 3 which used the lithium-containing silicon oxide containing Li₂Si₂O₅ as a main component, the cycle characteristics were significantly improved as compared to Comparative Examples 1 and 2 although the initial discharge capacities were slightly decreased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electrode active material for a nonaqueous electrolyte secondary battery comprising a composite of a lithium-containing silicon oxide and a silicon-containing compound which contains at least one of silicon and silicon oxide, wherein
the lithium-containing silicon oxide contains Li₂Si₂O₅ as a main component.

2. The electrode active material according to claim 1, wherein A/B, which is a ratio of intensity of a peak A positioned at 24.5° to 25.5° on the (111) face of Li₂Si₂O₅ and intensity of a peak B positioned at 23.3° to 24.0° on the (130) face of Li₂Si₂O₅ in a X-ray diffraction pattern of the composite measured using CuKα radiation, is 1 or more.

3. The electrode active material according to claim 1, wherein
when intensity of a peak A positioned at 24.5° to 25.5° on the (111) face of Li₂Si₂O₅, intensity of a peak C positioned at 33.5° to 34.0° on the (200) face of Li₄SiO₄, and intensity of a peak D positioned at 32.5° to 33.5° on the (130) face of Li₂SiO₃ are compared in a X-ray diffraction pattern of the composite measured using CuKα radiation,
the intensity of the peak A is larger than the intensity of the peak C, and the intensity of the peak A is at least 0.5 times the intensity of the peak D.

4. The electrode active material according to claim 1, wherein a part or the whole of the silicon-containing compound is coated with the lithium-containing silicon oxide.

5. The electrode active material according to claim 1, wherein the molar ratio Li/Si of lithium atoms contained in the silicon-containing compound and the lithium-containing silicon oxide to silicon atoms contained in the silicon-containing compound and the lithium-containing silicon oxide is 0.01 or higher and lower than 0.6.

6. The electrode active material according to claim 1, wherein the silicon-containing compound contains crystal silicon.

7. The electrode active material f according to claim 1, wherein the silicon-containing compound and the lithium-containing silicon oxide are integrated through a carbonaceous material.

8. A nonaqueous electrolyte secondary battery comprising a negative electrode, a positive electrode, and a nonaqueous electrolyte, wherein
at least one of the negative electrode and the positive electrode contain the electrode active material for a nonaqueous electrolyte secondary battery according to claim 1.
